(19) United States
(12) Patent Application Publication
(10) Pub. No.: US 2025/0310491 A1
(43) Pub. Date: Oct. 2, 2025

(54) ILLUMINATION OPTICS FOR PROJECTOR SYSTEMS

(71) Applicant: DOLBY LABORATORIES LICENSING CORPORATION

(72) Inventors: John David Jackson, Allen, TX (US); Darren Hennigan, Prosper, TX (US); Duane Scott Dewald, Addison, TX (US)

(73) Assignee: DOLBY LABORATORIES LICENSING CORPORATION, (US)

(21) Appl. No.: 18/864,376

(22) PCT Filed: May 11, 2023
(86) PCT No.: PCT/US2023/021840

§ 371 Date: Nov. 8, 2024

Related U.S. Application Data
(60) Provisional application No. 63/340,707, filed on May 11, 2022.

(51) Int. Cl. H04N 9/31; G02B 27/09

(52) U.S. Cl. CPC H04N 9/3152; G02B 27/0994; H04N 9/3161

(57) ABSTRACT

Illumination optics for projector systems having a high f-number light output. One projection system comprises a fiber input providing a first light, and a first illumination optics configured to alter the first light into a second light. The projection system comprises a Fourier lens assembly configured to receive the second light and to form a Fourier transform of the second light at an exit pupil of the Fourier lens assembly. The second light has a f-number between f/10 and f/30, the second light has a luminance uniformity between 75% and 90% of center, and the second light has a contrast over 10,000:1.

### CROSS-REFERENCE TO RELATED APPLICATIONS

This application claims priority to U.S. Provisional Application No. 63/340,707 filed on May 11, 2022, which is incorporated by reference in its entirety.

### BACKGROUND

### 1. Field of the Disclosure

This application relates generally to projection systems and, particularly, to illumination optics for laser-based image projection systems.

### 2. Description of Related Art

Digital projection systems typically utilize a light source and an optical system to project an image onto a surface or screen. The optical system includes components such as mirrors, lenses, waveguides, optical fibers, beam splitters, diffusers, spatial light modulators (SLMs), phase light modulators (PLMs), and the like. Some optical systems include illumination optic assemblies, or re-imaging optic assemblies, to redirect and condition light provided from a light source as it travels to SLMs or PLMs. Typically, light projected from the illumination optic assemblies have a low (e.g., fast) f-number.

### BRIEF SUMMARY OF THE DISCLOSURE

Illumination optic assemblies described herein provide for light having a high f-number (e.g., slow f-number) prior to being projected onto, or otherwise provided to, a modulation device. In traditional digital projection systems, increasing the f-number of light results in a decrease in uniformity. However, illumination optic assemblies described herein maintain high uniformity while achieving high f-number light. This increase in f-number results in a narrow illumination angle, assisting operations performed on the light downstream from the modulation devices, such as spatial filtering.

Various aspects of the present disclosure relate to devices, systems, and methods for projection display.

In one exemplary aspect of the present disclosure, there is provided a projection system comprising a fiber input providing a first light and a first illumination optics configured to alter the first light into a second light. The projection system includes a Fourier lens assembly configured to receive the second light and to form a Fourier transform of the second light at an exit pupil of the Fourier lens assembly. The second light has a f-number between f/10 and f/30. The second light has a luminance uniformity between 75% and 90% of center. The second light has a contrast over 10,000:1.

In another exemplary aspect of the present disclosure, there is provided a method for a projection system. The method includes providing, with a fiber input, a first light, and altering, with a first projection optics, the first light into a second light. The method includes receiving, with a Fourier lens assembly, the second light, and forming, with the Fourier lens assembly, a Fourier transform of the second light at an exit pupil of the Fourier lens assembly. The second light has a f-number between f/10 and f/30. The second light has a luminance uniformity between 75% and 90% of center. The second light has a contrast over 10,000:1.

In another exemplary aspect of the present disclosure, there is provided a non-transitory computer-readable medium storing instructions that, when executed by a processor of a projection system, cause the projection system to perform operations comprising providing, with a fiber input, a first light, altering, with a first projection optics, the first light into a second light, receiving, with a Fourier lens assembly, the second light, and forming, with the Fourier lens assembly, a Fourier transform of the second light at an exit pupil of the Fourier lens assembly. The second light has a f-number between f/10 and f/30. The second light has a luminance uniformity between 75% and 90% of center. The second light has a contrast over 10,000:1.

In this manner, various aspects of the present disclosure provide for the display of images having a high dynamic range and high resolution, and effect improvements in at least the technical fields of image projection, holography, signal processing, and the like.

### DESCRIPTION OF THE DRAWINGS

These and other more detailed and specific features of various embodiments are more fully disclosed in the following description, reference being had to the accompanying drawings, in which:

FIG. 1 illustrates a block diagram of an exemplary image projector display system according to various aspects of the present disclosure;

FIG. 2 illustrates an optical configuration of an exemplary projector system according to various aspects of the present disclosure;

FIG. 3A illustrates a plan view of an exemplary spatial light modulator for use with various aspects of the present disclosure;

FIG. 3B illustrates a cross-sectional view taken along the line II-B of FIG. 2A;

FIG. 4 illustrates a plan view of an exemplary phase light modulator for use with various aspects of the present disclosure;

FIG. 5 illustrates a cross-sectional view of another exemplary phase light modulator for use with various aspects of the present disclosure; and

FIG. 6 illustrates an exemplary projection lens according to various aspects of the present disclosure.

FIG. 7 illustrates a cross-sectional view of an exemplary optical fiber according to various aspects of the present disclosure.

FIG. 8 illustrates an exemplary illumination assembly according to various aspects of the present disclosure.

FIG. 9 illustrates another exemplary illumination assembly according to various aspects of the present disclosure.

FIG. 10A illustrates a vertical cross-section of an exemplary launch optics assembly according to various aspects of the present disclosure.

FIG. 10B illustrates a horizontal cross-section of the launch optics assembly of FIG. 10A according to various aspects of the present disclosure.

FIG. 11 illustrates an exemplary relay optics assembly according to various aspects of the present disclosure.

FIG. 12 illustrates another exemplary relay optics assembly according to various aspects of the present disclosure.

FIG. 13 illustrates another exemplary illumination assembly according to various aspects of the present disclosure.

FIG. 14 illustrates another exemplary launch optics assembly according to various aspects of the present disclosure.

### DETAILED DESCRIPTION

This disclosure and aspects thereof can be embodied in various forms, including hardware, devices, or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

Moreover, while the present disclosure focuses mainly on examples in which the various circuits are used in digital projection systems, it will be understood that this is merely one example of an implementation. It will further be understood that the disclosed systems and methods can be used in any device in which there is a need to project light; for example, cinema, consumer, and other commercial projection systems, heads-up displays, virtual reality displays, and the like.

### Projector Systems

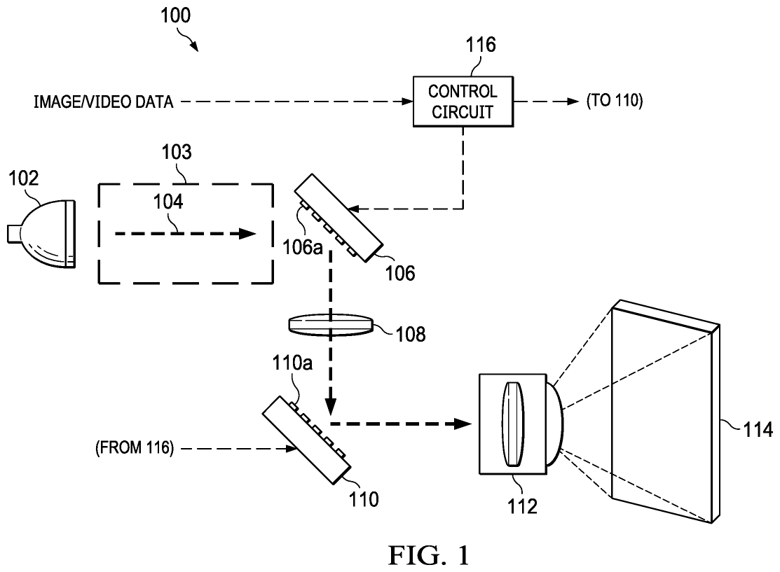

FIG. 1 illustrates one possible embodiment of a suitable image projector display system. In the illustrated embodiment, the projector display system is constructed as a dual/multi-modulator projection system 100. The projection system 100 employs a light source 102 that supplies the projector system with a desired illumination such that a final projected image will be sufficiently bright for the intended viewers of the projected image. Light source 102 may comprise any suitable light source, such as, but not limited to, Xenon lamps, laser(s), coherent light sources, and partially-coherent light sources. Additionally, optical systems described herein may implement optical fibers to transfer light from the light source 102 to optics within the optical system. While a light source and an optic fiber may be referred to separately, it is to be understood that the optic fiber is a component of the light source. Thus, reference to only the light source does not exclude the optic fiber.

Light 104 from the light source 102 may illuminate a first modulator 106 that may, in turn, illuminate a second modulator 110 via a set of optional optical components 108. Light from the second modulator 110 may be projected by a projection lens 112 (or other suitable optical components) to form a final projected image upon a screen 114. The first modulator 106 and the second modulator 110 may be controlled by a controller 116. The controller 116 may receive input image and/or video data and may perform certain image processing algorithms, gamut mapping algorithms or other such suitable processing upon the input image/video data and output control/data signals to the first modulator 106 and the second modulator 110 in order to achieve a desired final projected image on the screen 114. In addition, in some projector systems, it may be possible, depending on the light source, to modulate light source 102 (control line not shown) in order to achieve additional control of the image quality of the final projected image.

Light recycling module 103 is depicted in FIG. 1 as a dotted box that may be placed in the light path from the light source 102 to the first modulator 106. It may be appreciated that light recycling may be inserted into the projector system at various points in the projector system. For example, light recycling may be placed between the first and second modulators. In addition, light recycling may be placed at more than one point in the optical path of the display system.

While the embodiment of FIG. 1 is presented in the context of a dual, multi-modulation projection system, it should be appreciated that the techniques and methods of the present application will find application in single modulation, or other dual, multi-modulation display systems. For example, a dual modulation display system comprising a backlight, a first modulator (e.g., LCD or the like), and a second modulator (e.g., LCD or the like) may employ suitable optical components and image processing methods and techniques to affect the performance and efficiencies discussed herein in the context of the projection systems. It should also be appreciated that, even though FIG. 1 depicts a two-stage or dual modulator display system, the methods and techniques of the present application may also find application in a display system with only one modulator or a display system with three or more modulator (multi-modulator) display systems. The scope of the present application encompasses these various alternative embodiments.

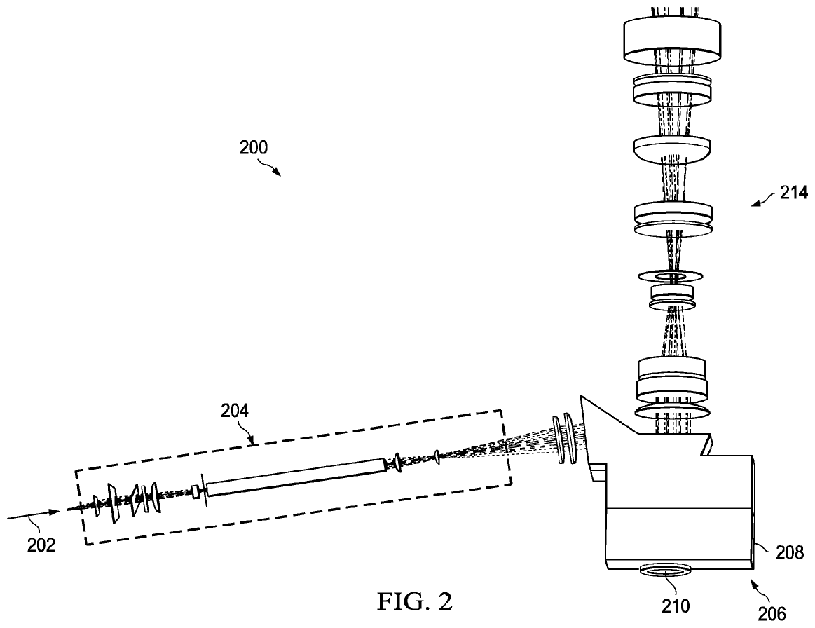

FIG. 2 illustrates another example projection system 200. The projection system 200 includes an illumination assembly 204 (e.g., illumination optics) that receives light from a fiber input 202 and feeds the light into a modulation assembly 206. The modulation assembly 206 includes a prism 208 and a modulator 210 (e.g., a reflector device). The modulator 210 may be configured as a digital light processing (DLP) device, as described below in more detail.

In some instances, the light from the fiber input 202 is a white light input, and the prism 208 is a white light prism. In such an instance, the prism 208 includes several prism pieces. For example, a spectral filter, such as a yellow notch filter, may be provided in the prism 208. Additional pieces may function as a TIR prism. In some embodiments, the modulation assembly 206 includes three modulators 210 (e.g., 3-chip) for modulating the received white light. The prism 208 splits the white light into several color beams (e.g., three color channels), one color beam for each modulator 210. A controller (such as the controller 116) may be coupled to each modulator 210 to control modulation of each color beam. The modulators 210 then modulate their respective color beam before combining the modulated color beams in the prism 208. In other embodiments, the modulator 210 modulates the white light directly. In both embodiments, the modulation assembly 206 then relays the output beam into projection optics 214 of the projection system 200. In some embodiments, the projection optics 214 are included in a projection lens. In other embodiments, a portion or section of the projection optics 214 are included in the projection lens.

In other instances, the projection system 200 includes several fiber inputs 202 from several color channels, such as a red color channel, a blue color channel, and a green color channel. In such an instance, the illustrated illumination assembly 204 receiving the fiber input 202 corresponds to only a single color channel provided to the prism 208. Several illumination assemblies 204 may be included to direct the light from the fiber inputs to the prism 208. In this instance, the prism 208 is a color light prism that receives each fiber input 202 and redirects each color channel to a respective modulator 210. Following modulation, the modulated color channels are combined and directed towards the projection optics 214.

### Exemplary Modulation Devices

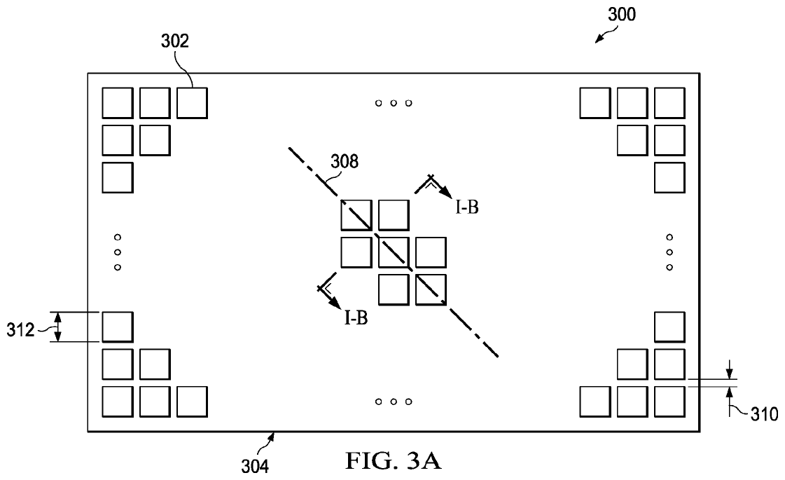

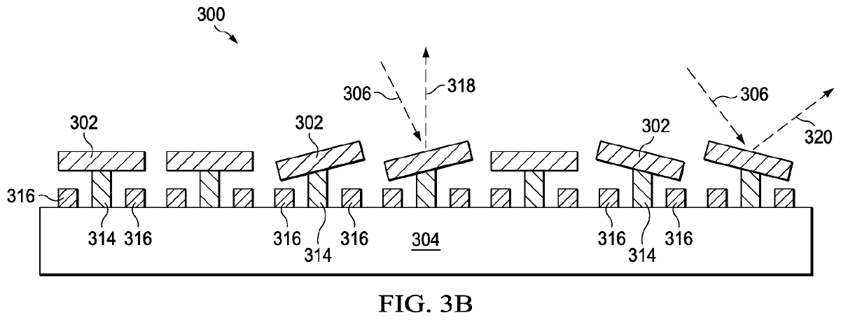

The modulator 210 (and, in some implementations, the first modulator 106 and the second modulator 110 in FIG. 1) may be configured as a DLP device. In some implementations, the modulator 210 is a digital micromirror device (DMD) composed of a plurality of mirrors used to adjust the angle of incidence of light. To illustrate the effects of the angle of incidence and the DMD mirrors, FIGS. 3A-3B show an exemplary DMD 300 in accordance with various aspects of the present disclosure. In particular, FIG. 3A illustrates a plan view of the DMD 300, and FIG. 3B illustrates partial cross-sectional view of the DMD 300 taken along line I-B illustrated in FIG. 3A. The DMD 300 includes a plurality of square micromirrors 302 arranged in a two-dimensional rectangular array on a substrate 304. Each micromirror 302 may correspond to one pixel of the eventual projection image, and may be configured to tilt about a rotation axis 308, shown for one particular subset of the micromirrors 302, by electrostatic or other type of actuation. The individual micromirrors 302 have a width 312 and are arranged with gaps of width 310 therebetween. The micromirrors 302 may be formed of or coated with any highly reflective material, such as aluminum or silver, to thereby specularly reflect light. The gaps between the micromirrors 302 may be absorptive, such that input light which enters a gap is absorbed by the substrate 304.

While FIG. 3A expressly shows only some representative micromirrors 302, in practice the DMD 300 may include many more individual micromirrors in a number equal to a resolution of the projection system 200. In some examples, the resolution may be 2K (2048×1080), 4K (4096×2160), 1080p (1920×1080), consumer 4K (3840×2160), and the like. Moreover, in some examples the micromirrors 302 may be rectangular and arranged in the rectangular array; hexagonal and arranged in a hexagonal array, and the like. Moreover, while FIG. 3A illustrates the rotation axis 308 extending in an oblique direction, in some implementations the rotation axis 308 may extend vertically or horizontally.

As can be seen in FIG. 3B, each micromirror 302 may be connected to the substrate 304 by a yoke 314, which is rotatably connected to the micromirror 302. The substrate 304 includes a plurality of electrodes 316. While only two electrodes 316 per micromirror 302 are visible in the cross-sectional view of FIG. 3B, each micromirror 302 may in practice include additional electrodes. While not particularly illustrated in FIG. 3B, the DMD 300 may further include spacer layers, support layers, hinge components to control the height or orientation of the micromirror 302, and the like. The substrate 304 may include electronic circuitry associated with the DMD 300, such as complementary metal-oxide semiconductor (CMOS) transistors, memory elements, and the like.

Depending on the particular operation and control of the electrodes 316, the individual micromirrors 302 may be switched between an “on” position, an “off” position, and an unactuated or neutral position. If a micromirror 302 is in the on position, it is actuated to an angle of (for example) −12° (that is, rotated counterclockwise by 12° relative to the neutral position) to specularly reflect input light 306 into on-state light 318. If a micromirror 302 is in the off position, it is actuated to an angle of (for example) +12° (that is, rotated clockwise by 12° relative to the neutral position) to specularly reflect the input light 306 into off-state light 320. The off-state light 320 may be directed toward a light dump that absorbs the off-state light 320. In some instances, a micromirror 302 may be unactuated and lie parallel to the substrate 304. The particular angles illustrated in FIGS. 3A-3B and described here are merely exemplary and not limiting. In some implementations, the on-and off-position angles may be between ±11 and ±13 degrees (inclusive), respectively. In other implementations, the on-and off-position angles may be between ±10 and ±18 degrees (inclusive), respectively.

In some implementations, the modulator 210 is a phase light modulator (PLM) configured to impart a spatially-varying phase modulation to the light. The PLM may be a reflective type, in which the PLM reflects incident light with a spatially-varying phase; alternatively, the PLM may be of a transmissive type, in which the PLM imparts a spatially-varying phase to light as it passes through the PLM. In some aspects of the present disclosure, the PLM has a liquid crystal on silicon (LCOS) architecture. In other aspects of the present disclosure, the PLM has a micro-electromechanical system (MEMS) architecture.

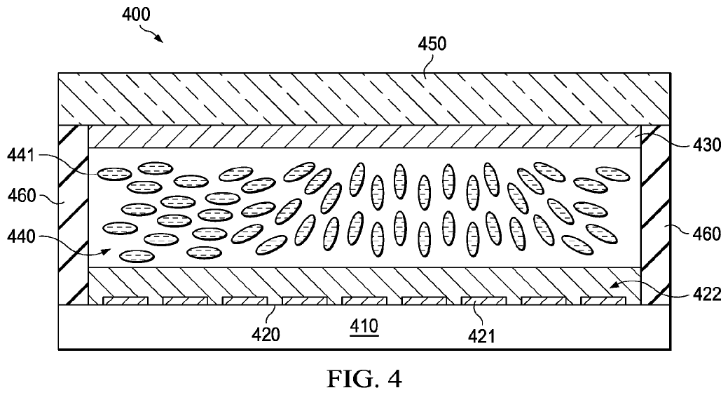

FIG. 4 illustrates one example of the modulator 210, implemented as a reflective LCOS PLM 400 and shown in a partial cross-sectional view. As illustrated in FIG. 4, the PLM 400 includes a silicon backplane 410, a first electrode layer 420, a second electrode layer 430, a liquid crystal layer 440, a cover glass 450, and spacers 460. The silicon backplane 410 includes electronic circuitry associated with the PLM 400, such as CMOS transistors and the like. The first electrode layer 420 includes an array of reflective elements 421 disposed in a transparent matrix 422. The reflective elements 421 may be formed of any highly optically reflective material, such as aluminum or silver. The transparent matrix 422 may be formed of any highly optically transmissive material, such as a transparent oxide. The second electrode layer 430 may be formed of any optically transparent electrically conductive material, such as a thin film of indium tin oxide (ITO). The second electrode layer 430 may be provided as a common electrode corresponding to a plurality of the reflective elements 421 of the first electrode layer 420. In such a configuration, each of the plurality of the reflective elements 421 will couple to the second electrode layer 430 via a respective electric field, thus dividing the PLM 400 into an array of pixel elements. Thus, individual ones (or subsets) of the plurality of the reflective elements 321 may be addressed via the electronic circuitry disposed in the silicon backplane 410, thereby to modify the state of the corresponding reflective element 421.

The liquid crystal layer 440 is disposed between the first electrode layer 420 and the second electrode layer 430, and includes a plurality of liquid crystals 441. The liquid crystals 441 are particles which exist in a phase intermediate a solid and a liquid; in other words, the liquid crystals 441 exhibit a degree of directional order, but not positional order. The direction in which the liquid crystals 441 tend to point is referred to as the “director.” The liquid crystal layer 440 modifies incident light entering from the cover glass 450 based on the birefringence An of the liquid crystals 441, which may be expressed as the difference between the refractive index in a direction parallel to the director and the refractive index in a direction perpendicular to the director. From this, the maximum optical path difference may be expressed as the birefringence multiplied by the thickness of the liquid crystal layer 440. This thickness is set by the spacer 460, which seals the PLM 400 and ensures a set distance between the cover glass 450 and the silicon backplane 410. The liquid crystals 441 generally orient themselves along electric field lines between the first electrode layer 420 and the second electrode layer 430. As illustrated in FIG. 4, the liquid crystals near the center of the PLM 400 are oriented in this manner, whereas the liquid crystals 441 near the periphery of the PLM 400 are substantially non-oriented in the absence of electric field lines. By addressing individual ones of the plurality of reflective elements 421 via a phase-drive signal, the orientation of the liquid crystals 441 may be determined on a pixel-by-pixel basis.

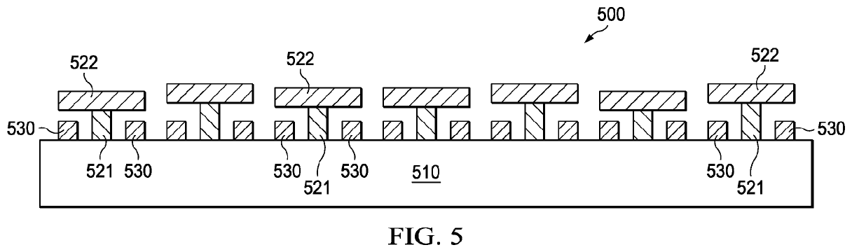

FIG. 5 illustrates another example of the modulator 210, implemented as a DMD PLM 500 and shown in a partial cross-sectional view. As illustrated in FIG. 5, the PLM 500 includes a backplane 510 and a plurality of controllable reflective elements as pixel elements, each of which includes a yoke 521, a mirror plate 522, and a pair of electrodes 530. While only two electrodes 530 are visible in the cross-sectional view of FIG. 5, each reflective element may in practice include additional electrodes. While not particularly illustrated in FIG. 5, the PLM 500 may further include spacer layers, support layers, hinge components to control the height or orientation of the mirror plate 522, and the like. The backplane 510 includes electronic circuitry associated with the PLM 500, such as CMOS transistors, a memory array, and the like.

The yoke 521 may be formed of or include an electrically conductive material so as to permit a biasing voltage to be applied to the mirror plate 522. The mirror plate 522 may be formed of any highly reflective material, such as aluminum or silver. The electrodes 530 are configured to receive a first voltage and a second voltage, respectively, and may be individually addressable. Depending on the values of a voltage on the electrodes 530 and a voltage (for example, the biasing voltage) on the mirror plate 522, a potential difference exists between the mirror plate 522 and the electrodes 530, which creates an electrostatic force that operates on the mirror plate 522. The yoke 521 is configured to allow vertical movement of the mirror plate 522 in response to the electrostatic force. The equilibrium position of the mirror plate 522, which occurs when the electrostatic force and a spring-like force of the yoke 521 are equal, determines the optical path length of light reflected from the upper surface of the mirror plate 522. Thus, individual ones of the plurality of controllable reflective elements are controlled to provide a number (as illustrated, three) of discrete heights and thus a number of discrete phase configurations or phase states. As illustrated, each of the phase states has a flat profile. In some aspects of the present disclosure, the electrodes 530 may be provided with different voltages from one another so as to impart a tilt to the mirror plate 522. Such tilt may be utilized with a light dump of the type described above.

The PLM 500 may be capable of high switching speeds, such that the PLM 500 switches from one phase state on the order of tens of μs, for example. In order to provide for a full cycle of phase control, the total optical path difference between a state where the mirror plate 522 is at its highest point and a state whether the mirror plate 522 is at its lowest point should be approximately equal to the wavelength λ of incident light. Thus, the height range between the highest point and the lowest point should be approximately equal to λ/2.

In some implementations, the PLM 500 creates fixed diffraction orders, where the mirror plates 522 produce multiple “copies” of the light impinging onto them. The PLM 500 steers the light within the extent of each diffraction order, producing multiple image “copies” at the reconstruction plane. An image steered by the PLM 500 may be formed on an image reconstruction plane at a distance at which the diffraction orders separate without overlapping. In some implementations, the image reconstruction plane is closer to the PLM 500 to alleviate blurring of the reconstructed image. A Fourier filter is implemented with the PLM 500 to remove overlap of diffraction orders at the image reconstruction plane. In some implementations, the diffraction patterns constructively interfere with each other to form the reconstructed image. Accordingly, if a portion of the light steered by the PLM 500 is blocked, the reconstructed image blurs compared to a reconstructed image including all light from the PLM 500.

### Example Projection Lens System

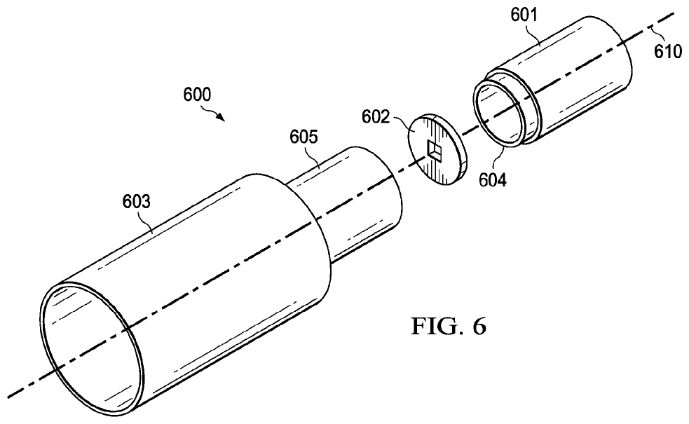

As previously described, modulated light from the modulation assembly is directed towards projection optics 214. In some implementations, the projection optics 214 is provided within a projection lens architecture. FIG. 6 is an exploded view of an exemplary projection lens system 600 according to various aspects of the present disclosure. The projection lens system 600 has a modular design. The projection lens system 600 includes a Fourier part 601 (for example, a Fourier lens assembly) configured to form a Fourier transform of an object at an exit pupil, an aperture 602, and a zoom part 603 (also referred to as a zoom lens assembly). The spatial Fourier transform imposed by the Fourier part 601 converts the propagation angle of each diffraction order of the modulated light to a corresponding spatial position on the Fourier plane. The Fourier part 601 thereby enables selection of desired diffraction orders, and rejection of undesired diffraction orders, by spatial filtering at the Fourier plane. The spatial Fourier transform of the modulated light at the Fourier plane is equivalent to a Fraunhofer diffraction pattern of the modulated light.

The Fourier part 601 includes a first attachment section 604, which may include threads, fasteners, and the like. The zoom part 603 includes a second attachment section 605, which may include complementary threads, fasteners, and the like to allow for mating with the first attachment sections 604. In one example, the first attachment section 604 includes a male threaded portion and the second attachment section 605 includes a female threaded portion, or vice versa. In another example, the first attachment section 604 and the second attachment section 605 are configured for a friction fit, in which case one or more fastening elements such as screws, cams, flanges, and so on may be provided. In yet another example, the first attachment section 604 may include one or more radial pins and the second attachment section 605 may include a corresponding number of L-shaped slots, or vice versa, to thereby connect the Fourier part 601 and the zoom part 603 using a bayonet connection. By these examples, the Fourier part 601 may be removably attached to the zoom part 603 to provide a modular assembly.

While FIG. 6 illustrates the Fourier part 601 and the zoom part 603 as being entirely separable, the present disclosure is not so limited. In some implementations, the Fourier part 601 and the zoom part 603 are only partially separable, for example by provided an access portion in one of the Fourier part 601 and the zoom part 603. the access portion may be a slot, a door, a window, and the like, such that an operator may access and/or swap the aperture 602 via the access portion. In such implementations, the Fourier part 601 and the zoom part 603 may be bonded (e.g., via an adhesive on the first attachment section 604 and/or the second attachment section 605) to prevent full separation. Alternatively, the Fourier part 601 and the zoom part 603 may be provided with an integral housing that includes the attachment portion.

The aperture 602 is configured to block a portion of light (e.g., modulated light corresponding to one or more diffraction orders) in the projection lens system 600 (e.g., modulated light provided via the modulation assembly 206). As illustrated in FIG. 6, the aperture 602 is a square opening having sides of, for example, 6 mm in length. FIG. 6 also illustrates an optical axis 610 of the projection lens system 600. When assembled, the Fourier part 601 and the zoom part 603 are substantially coaxial with one another and with the optical axis 610. In some implementations (for example, depending on the illumination angle), the aperture 602 is further substantially coaxial with the optical axis 610.

The projection lens system 600 may include or be associated with one or more non-optical elements, including a thermal dissipation device such as a heat sink (or cooling fins), one or more adhesives (or fasteners), and so on. In some implementations, the aperture 602 may block, and thus absorb, approximately 15% of incident light and therefore the heat sink or cooling fins may be positioned and configured so as to appropriately dissipate heat from the aperture 602. In some implementations, the aperture 602 is thermally isolated from other parts of the projection lens system 600.

The Fourier part 601 and the aperture 602 collectively operate as a Fourier lens with a spatial filter that may also be used as a fixed throw projection lens. The zoom part 603 illustrated in FIG. 6 may be one of a family of zoom lens assemblies configured to attach to the Fourier part 601, thereby to create the family of projection zoom lens systems and adapt to different theaters. In other words, the Fourier part 601 and the aperture 602 may be applicable to any theater setting, while the zoom part 603 provides a specific projection light pattern tailored to a particular theater. Therefore, by selecting a particular zoom part 603 from the family of zoom lens assemblies, and attaching the selected zoom part 603 to the Fourier part 601 and the aperture 602, a projection lens system 600 may be achieved which is adapted to the particular theater. Additionally, both the Fourier part 601 and the zoom part 3503 may include a plurality of individual lens elements.

### Exemplary Fiber Input

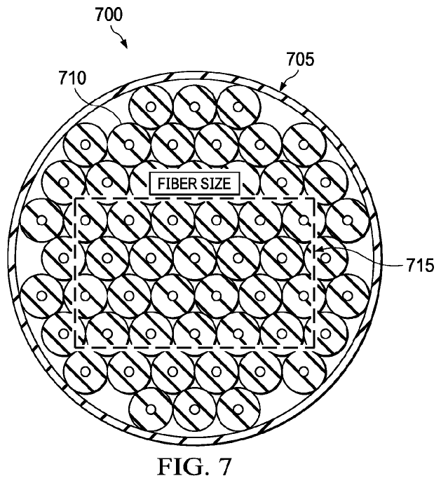

FIG. 7 provides one example optical fiber 700 for use with a light source (such as light source 102). The optical fiber 700 includes an outer cladding 705 and a plurality of inner fibers 710. The inner fibers 710 collectively form an output light projected by the optical fiber 700. In some implementations, the plurality of inner fibers 710 collectively form a circular light output provided to the illumination optics 204. In other implementations, a subset of the inner fibers 710 are utilized to form a rectangular fiber output, shown by rectangular portion 715. The rectangular portion 715 may have an aspect ratio that matches a downstream modulator, such as the first modulator 106 and/or the second modulator 110. In some embodiments, the optical fiber 700 has an aspect ratio of a 16 by 9 array of the inner fibers 710. In some embodiments, the optical fiber 700 is comprised of 10 to 200 single fibers (e.g., inner fibers 710). In some embodiments, the individual inner fibers 710 have diameters of approximately (e.g., ±50) 450 microns and have a numerical aperture (NA) of approximately 0.22.

### Exemplary Illumination Assemblies

In optical configurations, the f-number (denoted f/#) is the ratio of the system's focal length to the diameter of the aperture. As the f/# increases, uniformity of the light may be lost, resulting in additional artifacts in a projected image. Illumination assemblies described herein achieve a high f-number having a narrow illumination angle while maintaining uniformity in the light illuminated onto a modulation device.

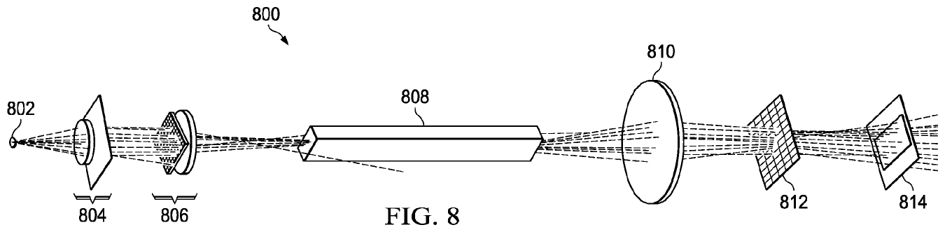

FIG. 8 provides an illumination assembly 800 as one possible embodiment of the illumination assembly 204. A laser fiber source 802 illuminates a set of optical elements 804 (e.g., a collimator) that provides substantial collimation to the light source. The substantially collimated light may thereafter illuminate an optical homogenizing element (e.g., a fly's-eye lens arrangement) 806. The fly's-eye lens arrangement may be arranged directly subsequent to the set of optical elements 804 that provides substantial collimation to the light source. The fly's-eye lens arrangement tends to provide suitable angular distribution of illumination, in combination with optical power sufficient to substantially focus the light onto an integrating rod 808. The fly's-eye lens arrangement may be arranged directly prior to the integrating rod 808, i.e., may be arranged directly adjacent to the integrating rod 808 along the light path through the illumination assembly 800. Thereafter, light from the integrating rod 808 may illuminate downstream optical element 810 that may provide additional optical power that may be desirable cross-sectional illumination (as depicted in imaginary plane 812). This illumination may thereafter illuminate a modulator 814. Additional details regarding the fly's-eye lens arrangement may be found in U.S. Pat. No. 10,281,730, “Optical System For Image Projectors,” herein incorporated by reference in its entirety.

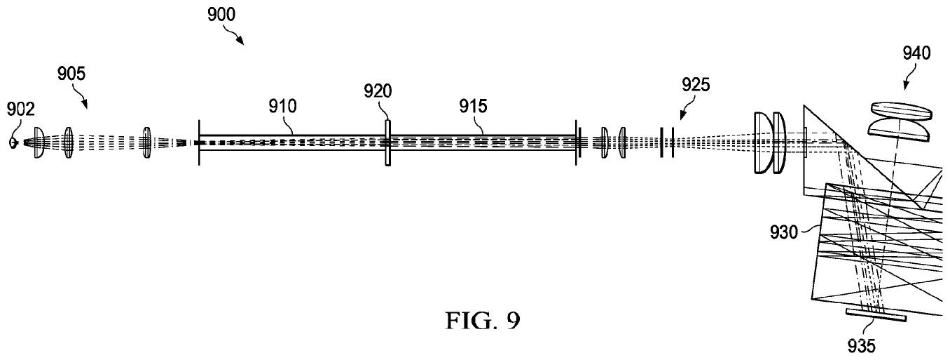

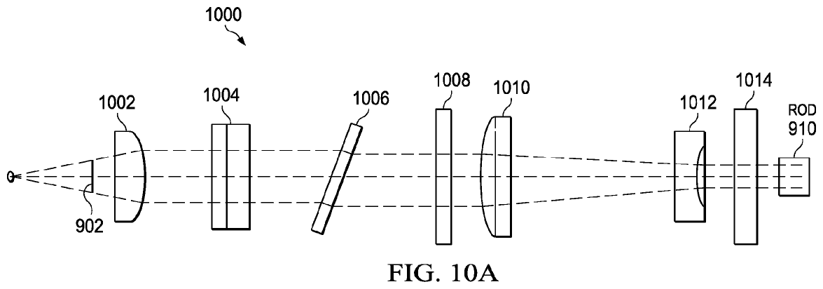

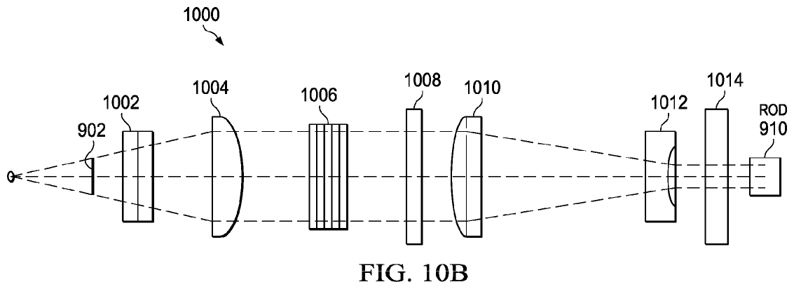

FIG. 9 provides an illumination assembly 900 as another possible embodiment of the illumination assembly 204. A laser light source 902 (e.g., the fiber input 202) illuminates (e.g., provides light to) a launch optics 905 (shown in more detail in FIG. 10). The launch optics 905 (e.g., re-imaging optics) focuses the light onto a first integrating rod 910. The light is illuminated from the first integrating rod 910 onto a second integrating rod 915. In some instances, a diffuser 920 is placed between the first integrating rod 910 and the second integrating rod 915 to remove artifacts and improve the uniformity of light traveling through the first integrating rod 910 and the second integrating rod 915. This configuration fills the entrance of the second integrating rod 915, maximizing the integration capabilities of the illumination assembly 900. The second integrating rod 915 directs the light towards a relay optics 925. In some implementations, the light directed by the second integrating rod 915 has a substantially rectangular shape. The relay optics 925 directs the light from the second integrating rod 915 towards a prism 930 to illuminate the prism 930. The prism 930 directs the light towards a modulation device 935, where the light is modulated. The modulated light is directed towards a projection lens 940. In some implementations, rather than implementing two separate integrating rods, a single integrating rod may be used to combine the launch optics 905 and the relay optics 925. The f/# of the light directed towards the prism 930 may be within a range of f/20 and f/30.

FIGS. 10A-10B provide an example launch optics 1000 that may be implemented as the launch optics 905 of FIG. 9. A first cylindrical lens 1002 receives light from the laser light source 902. The first cylindrical lens 1002 directs (or otherwise alters) the light onto a second cylindrical lens 1004. The second cylindrical lens 1004 directs the light onto a filter 1006 (e.g., a band-pass filter, a single color band-pass filter). The first cylindrical lens 1002 and the second cylindrical lens 1004 together function to collimate the light from the laser light source 902. The filtered light is directed onto a fly's-eye lens 1008. The fly's-eye lens 1008 directs the light onto a plano-convex lens 1010. The plano-convex lens 1010 directs the light onto a plano-concave lens 1012. The plano-concave lens 1012 directs the light onto the first integrating rod 910. A diffuser 1014 may be optically disposed between the plano-concave lens 1012 and the first integrating rod 910 to smooth high-frequency artifacts, improve spatial and angular uniformity of the light, and establish a Gaussian shape to the distribution of light.

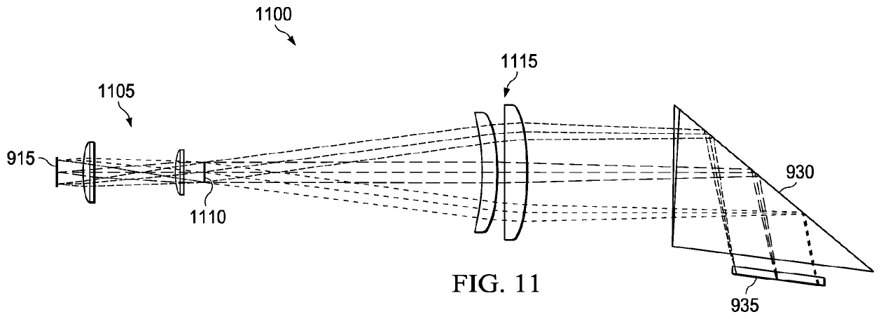

FIG. 11 provides an example relay optics 1100 that may be implemented as the relay optics 925 of FIG. 9. Light from the second integrating rod 915 is illuminated by a first lens assembly 1105 onto a second lens assembly 1115 and through an illumination aperture stop 1110. The first lens assembly 1105 and the second lens assembly 1115 re-image the end of the second integrating rod 915 onto a downstream modulator and magnify the image exiting the second integrating rod 915. Light at the illumination aperture stop 1110 may have an f/# of approximately f/15. In some instances, the light at the illumination aperture stop 1110 has an f/# of approximately f/25. The f/# of light at the illumination aperture stop 1110 may be dependent on the etendue of the light provided by the laser light source 902. The second lens assembly 1115 illuminates the light onto the prism 930, where the light is split into separate color channels and modulated at modulation device 935. Light at the modulation device 935 may have an f/# of approximately f/30.

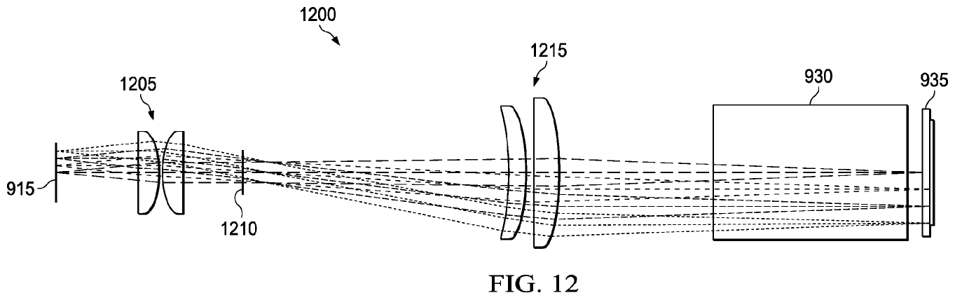

FIG. 12 provides another example relay optics 1200 that may be implemented as the relay optics 925 of FIG. 9. Light from the second integrating rod 915 is directed by a first lens assembly 1205 towards a second lens assembly 1215 and through an illumination aperture stop 1210. The second lens assembly 1215 illuminates the light onto the prism 930, where the light is split into separate color channels and modulated at modulation device 935.

While the example launch optics 1000 and example relay optics 1100, 1200 use a particular configuration of lenses, other lens configurations may be implemented to achieve the desired f/#, such as concave lenses, convex lenses, biconcave lenses, biconvex lenses, planoconcave lenses, planoconvex lenses, negative meniscus lenses, and positive meniscus lenses.

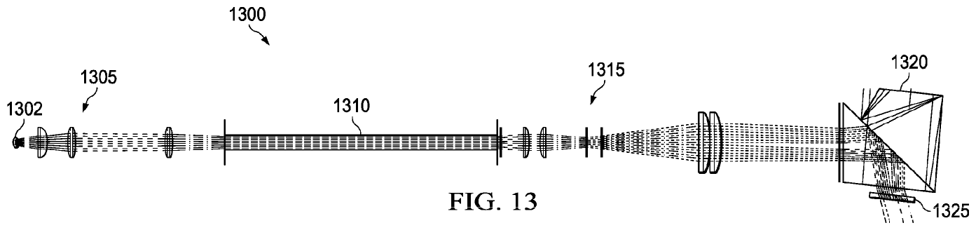

FIG. 13 provides another illumination assembly 1300 as a possible embodiment of the illumination assembly 204. A laser light source 1302 (e.g., the fiber input 202) illuminates (e.g., provides light to) a launch optics. The launch optics 1305 focuses the light onto an integrating rod 1310. The integrating rod 1310 directs the light towards a relay optics 1315. The light directed by the integrating rod 1310 may have a rectangular shape. The relay optics 1315 illuminates (or directs) the light from the integrating rod 1310 onto a prism 1320. The prism 1320 directs the light towards a modulator 1325, where the light is modulated. The f/# of the light illuminated onto prism 1320 may be within a range of f/10 and f/20. In some implementations, the f/# of the light illuminated onto the prism 1320 is 12.5 at an illumination aperture stop included within the relay optics 1315. In some instances, the example relay optics 1100 or the relay optics 1200 are implemented as the relay optics 1315 within the illumination assembly 1300.

The illumination assembly 1300 may be utilized with high-etendue light sources. Etendue is a measurement of the emitting area multiplied by the solid angle, and is related to terms such as mm²*sr (steradians), M² factor, or beam parameter product (BPP). More specifically, etendue may be provided as: π*Area*NA². Accordingly, the light projected by a single fiber light input has a lower etendue than the light projected by a cluster of fiber light inputs (such as the plurality of inner fibers 710 of FIG. 7). High-etendue light sources may have an etendue of, for example, 0.2 mm²*sr to 50 mm²*sr. Single fibers disclosed herein having a diameter of approximately 450 microns may have an etendue of approximately 0.024 mm²*sr. Fibers having a diameter of approximately 100 microns may have an etendue of approximately 0.0012 mm²*sr.

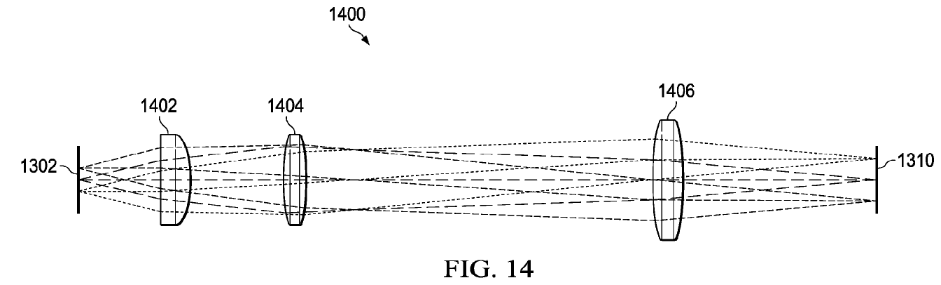

FIG. 14 provides an example launch optics 1400 that may be implemented as the launch optics 1305 of FIG. 13. A plano-convex lens 1402 receives the light from the laser light source 1302 and illuminates the light onto a first equi-convex lens 1404. The first ECX lens 1404 receives the light and illuminates the light onto a second equi-convex lens 1406. The second ECX lens 1406 receives the light and illuminates the light onto the integrating rod 1310. In some implementations, the launch optics 1400 magnifies the light from the laser light source 1302 as it is directed onto the integrating rod 1310.

### Uniformity and Efficiency Analysis

Examples of the illumination assembly 204 provide for the implementation of high f/# while maintaining high uniformity (e.g., macroscopic uniformity, blotch uniformity from modal noise, and speckle uniformity of fine-grain spots) across projected images. Luminance uniformity of the projected image is expressed as a percentage of the luminance value at the sides and corners of the image relative to the value at the center of the image. Luminance uniformity of images projected by the projection system 200 may be, for example, be between 75% and 90% of center, between 80% and 90% of center, and between 85% and 90% of center.

Additionally, white chromaticity uniformity is measured at the corners of the projected image, and is computed separately for each location as the x or y value for that location minus the x or y value at the center of the image. Examples of the illumination assembly 204 achieve white chromaticity uniformity ranging from within ±0.000x, ±0.000y of center to ±0.015x, ±0.015y of center.

Accordingly, examples of the illumination assembly 204 described herein provide for slow f/#s (f/# greater than f/10) that assist in the filtering of undesired diffraction orders at the Fourier filter. Additionally, the examples of the illumination assembly 204 described herein maintain a high efficiency and high uniformity of the projected images while achieving the slow f/# values. Image contrast ranges achieved by the examples of the illumination assembly 204 may range from 10,000:1 to 20,000:1, from 20,000:1 to 30,000:1, from 30,000:1 to 40,000:1, or be greater than 40,000:1.

Systems, methods, and devices in accordance with the present disclosure may take any one or more of the following configurations.
(1) A projection system comprising: a fiber input providing a first light; a first illumination optics, the first illumination optics configured to alter the first light into a second light; and a Fourier lens assembly configured to receive the second light and to form a Fourier transform of the second light at an exit pupil of the Fourier lens assembly, wherein the second light has a f-number between f/10 and f/30, wherein the second light has a luminance uniformity between 75% and 90% of center, and wherein the second light has a contrast over 10,000:1.
(2) The projection system according to (1), wherein the first illumination optics includes: a first integrating rod; a second integrating rod; and a diffuser between the first integrating rod and the second integrating rod.
(3) The projection system according to (2), wherein the first illumination optics includes: a collimating lens substantially collimating the first light from the fiber input onto the first integrating rod.
(4) projection system according to any one of (2) to (3), further comprising: a relay optics assembly configured to receive the second light from the first illumination optics and redirect the second light into a third light, wherein the relay optics includes an aperture stop, and wherein the f-number of the second light passing through the aperture stop is approximately f/12.
(5) The projection system according to any one of (1) to (4), further comprising: a prism configured to receive the second light from the illumination optics and redirect the second light into a third light; and a modulation device configured to receive the third light and modulate the third light into a fourth light, wherein the Fourier lens assembly is configured to receive the fourth light and to form a Fourier transform of the fourth light at the exit pupil of the Fourier lens assembly to generate a filtered light output.
(6) The projection system according to (5), wherein the third light received by the modulation device has a f-number of approximately f/30.
(7) The projection system according to any one of (5) to (6), wherein the Fourier lens assembly is integrated within a projection lens assembly, the projection lens assembly configured to project the filtered light output.
(8) The projection system according to any one of (1) to (7), wherein the f-number of the second light is between f/10 and f/20.
(9) The projection system according to any one of (1) to (7), wherein the f-number of the second light is between f/20 and f/30.
(10) The projection system according to any one of (1) to (9), wherein the fiber input is a bundle of optical fibers configured in a rectangular array.
(11) A method for a projection system, the method comprising: providing, with a fiber input, a first light; altering, with a first illumination optics, the first light into a second light; receiving, with a Fourier lens assembly, the second light; and forming, with the Fourier lens assembly, a Fourier transform of the second light at an exit pupil of the Fourier lens assembly, wherein the second light has a f-number between f/10 and f/30, wherein the second light has a luminance uniformity between 75% and 90% of center, and wherein the second light has a contrast over 10,000:1.
(12) The method according to (11), wherein the first illumination optics includes: a first integrating rod; a second integrating rod; and a diffuser between the first integrating rod and the second integrating rod.
(13) The method according to (12), further comprising: collimating, with a collimating lens, the first light from the fiber input onto the first integrating rod.
(14) The method according to any one of (12) to (13), further comprising: receiving, with a relay optics assembly, the second light from the first illumination optics, and redirecting, with the relay optics assembly, the second light into a third light, wherein the relay optics assembly includes an aperture stop, and wherein the f-number of the second light passing through the aperture stop is approximately f/12.
(15) The method according to any one of (11) to (14), further comprising: receiving, with a prism, the second light from the first illumination optics, redirecting, with the prism, the second light into a third light, receiving, with a modulation device, the third light, modulating, with the modulation device, the third light into a fourth light, receiving, with the Fourier lens assembly, the fourth light, and forming, with the Fourier lens assembly, a Fourier transform of the fourth light at the exit pupil of the Fourier lens assembly to generate a filtered light output.
(16) The method according to (15), wherein the third light received by the modulation device has a f-number of approximately f/30.
(17) The method according to any one of (15) to (16), wherein the Fourier lens assembly is integrated within a projection lens assembly, and wherein the method further comprises: projecting, with the projection lens assembly, the filtered light output.
(18) The method according to any one of (11) to (17), wherein the f-number of the second light is between f/10 and f/20.
(19) The method according to any one of (11) to (17), wherein the f-number of the second light is between f/20 and f/30.
(20) A non-transitory computer-readable medium storing instructions that, when executed by a processor of a projection system, cause the projection system to perform operations comprising the method according to any one of (11) to (19).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1-20. (canceled)

21. A projection system comprising:
an illumination assembly, the illumination assembly comprising:
a fiber input providing a first light; and
first illumination optics, the first illumination optics configured to alter the first light into a second light;
a modulation assembly configured to alter the second light into a third light; and
projection optics configured to receive the third light and form a projected image upon a screen, the projection optics comprising a Fourier lens assembly configured to form a Fourier transform of the third light at an exit pupil of the Fourier lens assembly,
wherein the illumination assembly has an f-number between f/10 and f/30;
wherein the projection optics are configured to form a projected image having a luminance uniformity between 75% and 90%, calculated as a percentage of the luminance value at the sides and corners of the image relative to the value at the center of the image, and
wherein:
(1) the fiber input is a bundle of optical fibers configured in a rectangular array;
(2) the first illumination optics comprises a first integrating rod, a second integrating rod, and a diffuser between the first integrating rod and the second integrating rod; or
(3) the first illumination optics comprises a fly's-eye lens arrangement.

22. The projection system of claim 21, wherein the first illumination optics includes:
the first integrating rod;
the second integrating rod; and
the diffuser between the first integrating rod and the second integrating rod.

23. The projection system of claim 22, wherein the illumination assembly further comprises a relay optics assembly configured to direct the second light towards the modulation assembly,
wherein the relay optics assembly includes an aperture stop, and wherein the f-number of the second light passing through the aperture stop is approximately f/12.

24. The projection system of claim 21, wherein the first illumination optics includes:
a collimating lens configured to substantially collimate the first light from the fiber input onto the first integrating rod or fly's eye lens arrangement.

25. The projection system of claim 21, wherein the modulation assembly comprises a prism and a modulation device, wherein the prism is configured to receive the second light from the first illumination optics and redirect the second light to the modulation device, and wherein the modulation device is configured to receive the second light and modulate the second light into the third light.

26. The projection system of claim 25, wherein the second light received by the modulation device has a f-number of approximately f/30.

27. The projection system of claim 21, wherein the f-number of the second light is between f/10 and f/20.

28. The projection system of claim 21, wherein the f-number of the second light is between f/20 and f/30.

29. The projection system of claim 21, wherein the fiber input is a bundle of optical fibers configured in a rectangular array.

30. A method for a projection system, the method comprising:
providing, with a fiber input of an illumination assembly, a first light;
altering, with a first illumination optics of the illumination assembly, the first light into a second light,
wherein: (1) the fiber input is a bundle of optical fibers configured in a rectangular array, (2) the first illumination optics comprises a first integrating road, a second integrating rod, and a diffuser between the first integrating rod and the second integrating rod, or (3) the first illumination optics comprises a fly's eye lens arrangement;
receiving, with a modulation assembly, the second light, and altering the second light into a third light;
receiving, by projection optics comprising a Fourier lens assembly, the third light;
forming, with the Fourier lens assembly, a Fourier transform of the third light at an exit pupil of the Fourier lens assembly; and
forming, by the projection optics, a projected image upon a screen, wherein the image has a luminance uniformity between 75% and 90% of center, wherein the luminance uniformity of an image is calculated as a percentage of the luminance value at the sides and corners of the image relative to the value at the center of the image,
wherein the illumination assembly has a f-number between f/10 and f/30.

31. The method of claim 30, wherein the first illumination optics includes:
the first integrating rod;
the second integrating rod; and
the diffuser between the first integrating rod and the second integrating rod.

32. The method of claim 31, further comprising:
collimating, with a collimating lens, the first light from the fiber input onto the first integrating rod.

33. The method of claim 32, further comprising:
redirecting, with a relay optics assembly of the illumination assembly, the second light to the modulation assembly,
wherein the relay optics assembly includes an aperture stop, and wherein the f-number of the second light passing through the aperture stop is approximately f/12.

34. The method of claim 30, further comprising:
receiving, with a prism, the second light from the first illumination optics,
redirecting, with the prism, the second light to a modulation device,
modulating, with the modulation device, the second light into the third light.

35. The method of claim 34, wherein the third light received by the modulation device has a f-number of approximately f/30.

36. The method of claim 30, wherein the f-number of the second light is between f/10 and f/20.

37. The method of claim 30, wherein the f-number of the second light is between f/20 and f/30.
